(19) United States
(12) Patent Application Publication
(10) Pub. No.: US 2014/0269500 A1
(43) Pub. Date: Sep. 18, 2014

(54) SYSTEMS AND METHODS FOR HANDLING INCOMING COMMUNICATIONS DIRECTED TO A TELEPHONY DEVICE

(71) Applicant: VONAGE NETWORK, LLC, Holmdel, NJ (US)

(72) Inventors: TZAHI EFRATI, GIVATAIM (IL); GUY FIGHEL, RED BANK, NJ (US)

(73) Assignee: VONAGE NETWORK, LLC, HOLMDEL, NJ (US)

(21) Appl. No.: 13/837,253

(22) Filed: Mar. 15, 2013

(51) Int. Cl. H04W 76/06

(52) U.S. Cl. CPC H04W 76/064
USPC 370/328

(57) ABSTRACT

Systems and methods for terminating telephony communications to a mobile telephony device via a data network make use of a forwarding termination service. The forwarding termination service causes a native mobile telephony service provider that provides service to the mobile telephony device to forward incoming telephony communications directed the native telephone number of the mobile telephony device to a forwarding access number. The forwarding termination service receives telephony communications directed to the forwarding access number, and then terminates the telephony communications to the mobile telephony device via any one of multiple different methods. The mobile telephony service provider can be instructed to implement and cancel call forwarding instructions by a forwarding agent that is separate from the forwarding termination service.

### BACKGROUND OF THE INVENTION

The invention is related to systems and methods for terminating telephony communications to a telephony device. More specifically, the invention relates to systems and methods for terminating telephony communications to a telephony device via a non-native Internet Protocol (IP) telephony system.

Mobile telephony devices, such as cellular telephones and mobile computing devices with cellular telephony capabilities, are typically provided their native telephony service by a cellular telephony service provider. However, such telephony devices are also often capable of running software applications which can conduct an Internet protocol telephony communication via a data network, such as the Internet. Thus, it is possible for a single telephony device to conduct telephony communications through both a cellular telephony services provider and an Internet protocol telephony services provider.

Because most telephony devices are primarily designed to conduct telephony communications via a cellular telephony system, if a user is conducting an IP telephony communication via a data network when a new incoming cellular telephony communication is received by the telephony device, the telephony device either terminates the IP telephony communication (so that the cellular telephony communication can be received), or the IP telephony communication is placed on hold so that the cellular telephony communication can be initiated. In many cases, this interruption of the IP telephony communication is undesirable.

In addition, many telephony devices are used for functions other than conducting telephony communications. For example, many new smart phones allow a user to play prerecorded music, or stream music via a data connection. Many smart phones also allow a user to play games and conduct other functions using the telephony device's display, audio capabilities and installed software.

Here again, if a user is conducting a function other than conducting a cellular based telephony communication, and a new incoming cellular telephony communication is received by the telephony device, the telephony device typically terminates the ongoing function so that the incoming cellular telephony communication can be received. The automatic termination of the other function when a new cellular communication is also undesirable.

It would be desirable for a telephony device to operate such that when the telephony device is performing a function other than conducting a cellular telephony communication, and a new cellular telephony communication is received, the user is provided with an option to either continue with the original function, or to receive the incoming cellular telephony communication.

### BRIEF DESCRIPTION OF THE FIGURES

FIG. 1 is diagram illustrating how an IP telephony system and a telephony device according to one embodiment of the invention interact with other elements of a communications environment;

FIG. 2 is a schematic diagram of a controller that may be used in an IP telephony system or a telephony device according to one embodiment of the invention;

FIG. 3 is a block diagram illustrating selected elements of an IP telephony system according to one embodiment of the invention;

FIG. 4 is a block diagram illustrating selected elements of a telephony device according to one embodiment of the invention;

FIG. 5 illustrates how a forwarding agent can be utilized by an IP telephony system embodying the invention or a telephony device embodying the invention to cause a telephony service provider to implement or cancel forwarding instructions;

FIG. 6 is a flow diagram illustrating steps of a method that could be performed by an IP telephony system according to one embodiment of the invention to terminate forwarded communications;

FIG. 7 if a flow diagram illustrating steps of a method that could be performed by a telephony device according to one embodiment of the invention to handle incoming forwarded communications; and

FIG. 8 is a flow diagram illustrating steps of a method that could be performed by an IP telephony system or a telephony device according to one embodiment of the invention to cause a telephony service provider to implement or cancel forwarding instructions.

### DETAILED DESCRIPTION OF PREFERRED EMBODIMENTS

In the following description, references will be made to an “IP telephony device.” This term is used to refer to any type of device which is capable of interacting with an IP telephony system to complete a telephone call. An IP telephony device could be an IP telephone, a computer running IP telephony software, a terminal adapter which is connected to an analog telephone, or some other type of device capable of communicating via data packets. An IP telephony device could also be a cellular telephone or a portable or tablet computing device that runs a software client that enables the device to act as an IP telephone. Thus, a single device might be capable of operating as both a cellular telephone and an IP telephony device.

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod Touch™ can interact with an IP telephony system to conduct a telephone call.

The following description will also refer to telephony communications and telephony activity. These terms are intended to encompass all types of telephony communications, regardless of whether all or a portion of the communications are carried in an analog or digital format. Telephony communications could include audio or video telephone calls, facsimile transmissions, text messages, SMS messages, MMS messages, video messages, and all other types of telephony and data communications sent by or received by a user. These terms are also intended to encompass data communications that are conveyed through a PSTN or VOIP telephony system. In other words, these terms are intended to encompass any communications whatsoever, in any format, which traverse all or a portion of a communications network or telephony network.

In the following description, the term “call” or “telephone call” may be used in certain instances for ease of reference, clarity and brevity. However, the systems and methods described below, which handle, route and terminate calls may also be capable of handling, routing and terminating other forms of telephony-based communications. Thus, the terms call and telephone call are intended to include other forms of telephony-based communications beyond voice and video calls.

The following description also refers to terminating a telephony communication. This phrase could mean completing an incoming telephony communication, such as a voice or video telephone call, to a telephony device. However, terminating an incoming communication could include activities other than completing the incoming telephony communication to a telephony device. Instead, terminating an incoming telephony communication could include sending the calling party to voicemail, or forwarding the incoming communication to an alternate telephone number or telephony device. Terminating an incoming telephony communication could also include playing a message to the calling party, and then terminating the call. Alternatively, an interactive voice response system could be performed for the calling party such that the calling party is capable of performing one or more functions. Virtually any way of handling an incoming telephony communication could be termed terminating the communication.

The following description makes references to a native telephony service provider. In the case of cellular telephones or smart phones with cellular capabilities, the native telephony service provider is often the cellular service provider that provides a cellular telephone or a smart phone with its cellular service. The native telephony service provider typically assigns a telephone number to the telephony device, which other parties can use to direct communications to the telephony device.

Note, when a user purchases a telephony device, it will often be provided with its native telephony service from a first cellular service provider. However, the user of the telephony device can terminate the original service agreement with the first cellular service provider and register the telephony device with a second cellular service provider that provides the telephony device with its native telephony service. An original telephone number assigned by the first cellular service provider can be retained, or the second cellular service provider can assign a new telephone number. Thus, the first cellular service provider to have provided a telephony device with cellular service may not always be the native telephone service provider. For purposes of the following the description, the native telephony service provider is the telephony service provider that is currently providing the telephony device with its cellular service.

The following description also refers to an identifier that is assigned to or associated with a telephony device. In many instances, the identifier is a telephone number that is assigned to or associated with a telephone device. In other instances, the identifier could take other forms. Virtually any string of characters capable of uniquely identifying a telephony device could be used as an identifier for the telephony device. The native identifier of a telephony device is typically assigned to the telephony device by the native telephony service provider.

In many instances, when a cellular telephony service provider receives a new incoming telephony communication which is directed to the native identifier of a telephony device, the cellular telephony services provider will have little or no information about any activity which is currently being conducted on the telephony device. As a result, the cellular telephony service provider simply attempts to terminate the incoming communication to the telephony device. No check is performed to determine if other activity is currently being conducted on the telephony device. For the reasons explained above, this can result in the new incoming cellular communication interrupting an ongoing function.

When a user has activated a software program on the telephony device which is used to conduct an IP based telephony communication, the software application is often able to determine the status of the telephony device at any given point in time. Thus, an IP telephony software application on a telephony device could be used to determine whether the user is conducting some other activity when a new incoming telephony communication is received. In addition, because the software application can be configured to communicate with an IP telephony service provider via a data network connection, information gathered by the software application regarding the current status of the telephony device can be forwarded to the IP telephony service provider.

Indeed, any software application that is running on a telephony device may be capable of determining the present status of the telephony device and determining whether the telephony device is performing a function. Thus, a software application on a telephony device could have as its purpose, the determination and reporting of the status of the device.

In systems and methods embodying the invention, an IP telephony service provider issues forwarding instructions to a telephony device's native telephony service provider which causes the native telephony service provider to forward any incoming communications that are directed to the native identifier of the telephony device to the IP telephony system. Elements of the IP telephony system then check with a software application which is being run on the telephony device to determine if the telephony device is presently conducting some other activity which should not be interrupted by the incoming communication. Alternatively, the IP telephony system may cause a query to be displayed to the user, asking if the user would like to receive the new incoming communication. If no activity is being conducted, or if the user indicates that he wishes to receive the incoming communication, the IP telephony system forwards the new incoming communication to the telephony device via the data network connection. In other words, the incoming communication which was originally directed to the native identifier of the telephony device, and which has been forwarded from the native telephony service provider to the IP telephony service provider, is connected to the telephony device in an IP telephony format.

Where the IP telephony system is able to cause a notification to be displayed to the user, the user may have the option of answering the call, or declining the call. The user might have a variety of additional options, such as sending the call to voicemail, forwarding the call to an alternate telephone number, or causing a message to be played to the calling party before the communication is terminated.

In other embodiments of the invention, the software application on the device itself could receive the incoming telephony communication from the IP telephony system, and the software application on the telephony device could interact with the user to determine how to handle the incoming communication. In this instance, the IP telephony system simply connects an incoming communication which has been forwarded from the native telephony service provider, and the software application on the telephony device determines how to handle the incoming communication, either with or without the user's input. If the user is already performing some other function with the telephony device when the incoming telephony communication is received, the software application on the telephony device could give the user the option to either accept the new incoming communication, or ignore it so that the function already being performed can be continued.

In order for the above actions to be performed, it is first necessary for any incoming telephony communication directed to the native identifier of the telephony device, and which is first received by the native telephony service provider, to be forwarded to an IP telephony services provider which can then terminate the incoming telephony communication to a software application on the telephony device. Thus, it is first necessary to cause the native telephony service provider to implement forwarding instructions. As will be explained below, those forwarding instructions can be implemented and canceled depending on conditions which exist on the telephony device.

FIG. 1 depicts various elements of a communications environment 100 that may be involved in terminating telephony communications to a telephony device in accordance with aspects of the invention. The elements in FIG. 1 include an IP telephony system 124 which can communicate with various other devices and systems via the Internet 116, and/or via gateways 120A, 120B. Mobile telephony service provider A 114 provides telephony service to mobile telephony devices located in country 1. Mobile telephony service provider A 114 could be, for example, a cellular telephony network. FIG. 1 also depicts a traditional publically switched telephone network (PSTN) 130. An analog telephone 132 can utilize the PSTN 130 to place and receive calls. FIG. 1 also depicts a cellular telephone 110 that is provided with service by mobile telephony service provider A 114. FIG. 1 further depicts an IP telephony device 111 that can conduct IP based telephony communications over the Internet 116. The IP telephony device 111 could receive service from the IP telephony system 124, or from other telephony service providers. FIG. 1 also illustrates a first IP telephony device with cellular capabilities 109. The first telephony device 109 can conduct telephony communications either via the mobile telephony service provider A 114, or via the IP telephony system 124, using the Internet 116. All of the above-described elements are located in a first country.

FIG. 1 shows that a second IP telephony device with cellular capabilities 112 may be located in a second country. The second telephony device 112 can conduct cellular based telephony communications via mobile telephony service provider B 140 located in a second country, or IP based telephony communications using the IP telephony system 124. As illustrated in FIG. 1, a wireless interface 118 in the second country may be used by the second telephony device 112 to access the Internet 116, and thereby communicate with the IP telephony system 124.

In some instances, the first telephony device 109 and the second telephony device 112 are capable of establishing a data connection to the Internet 116 either directly, or via a wireless interface 118. In other embodiments, the first telephony device 109 and second telephony device 112 may be capable of establishing a data link to a data network, such as the Internet 116, via a data channel provided by mobile telephony service provider A 114 or mobile telephony service provider B 140. The data channel may be separate from a channel used for audio or video communications that are established through the mobile telephony service providers 114/140.

FIG. 2 illustrates elements of a computer processor 250 that can be used as part of the IP telephony system 124, or as part of an IP telephony device, to accomplish various functions. The IP telephony system 124 or an IP telephony device could include multiple processors 250, along with their operating components and programming, each carrying out a specific or dedicated function.

The processor 250 shown in FIG. 2 may be one of any form of a general purpose computer processor used in accessing an IP-based network, such as a corporate intranet, the Internet or the like. The processor 250 comprises a central processing unit (CPU) 252, a memory 254, and support circuits 256 for the CPU 252. The processor 250 also includes provisions 258/260 for connecting the processor 250 to customer equipment, to service provider equipment, to IP network or gateways, as well as possibly one or more input/output devices (not shown) for accessing the processor and/or performing ancillary or administrative functions related thereto. The provisions 258/260 are shown as separate bus structures in FIG. 2; however, they may alternately be a single bus structure without degrading or otherwise changing the intended operability of the processor 250.

The memory 254 is coupled to the CPU 252. The memory 254, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 256 are coupled to the CPU 252 for supporting the processor in a conventional manner. These circuits include cache, power supplies, clock circuits, input/output circuitry and subsystems, and the like.

A software routine 262, when executed by the CPU 252, causes the processor 250 to perform processes of the disclosed embodiments, and is generally stored in the memory 254. The software routine 262 may also be stored and/or executed by a second CPU (not shown) that is remotely located from the hardware being controlled by the CPU 252. Also, the software routines could also be stored remotely from the CPU. For example, the software could be resident on servers and memory devices that are located remotely from the CPU, but which are accessible to the CPU via a data network connection.

The software routine 262, when executed by the CPU 252, transforms the general purpose computer into a specific purpose computer that performs one or more functions of an IP telephony system 124 or an IP telephony device. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 262 of the disclosed embodiments is capable of being executed on any computer operating system, and is capable of being performed using any CPU architecture.

FIG. 3 illustrates an IP telephony system in accordance with one embodiment of the invention. The IP telephony system 300 includes a call set up unit 302, a CDR unit 304 and a billing unit 306. The CDR unit 304 receives and processes call detail records relating to the communications that are handled by the IP telephony system 300. The billing unit 306 uses information contained in the CDR unit 304 to bill customers for processing the communications.

The IP telephony system 300 also includes a forwarded call termination unit 310. The forwarded call termination unit 310 is responsible for receiving calls which have been forwarded from a different telephony system, and for terminating those calls either to a telephony device, or in some other fashion.

The forwarded call termination unit 310 includes a registration unit 312, which is responsible for registering telephony devices which communicate with the IP telephony system 300 via a data network. The forwarded call termination unit 310 also includes a triggering unit 314, which is responsible for determining when call forwarding instructions should be implemented by another telephony system, and for determining when previously implemented forwarding instructions should be cancelled. A forwarding instruction unit 316 is responsible for causing forwarding instructions to be implemented and cancelled by other telephony systems. Finally, the forwarded call termination unit 310 includes a communications termination unit 318 which is responsible for terminating incoming telephony communications which have been forwarded from another telephony system. How the various elements of the IP telephony system 300 described above act in order to accomplish methods in accordance with the invention is described in detail below.

FIG. 4 illustrates a telephony device 400 in accordance with one embodiment of the invention. The telephony device 400 includes a wireless data transceiver 402 which is configured to establish a wireless data link with a data network, such as the Internet. The telephony device 400 also includes a wireless cellular transceiver 404 which is responsible for establishing a wireless link to one or more elements of a cellular telephony system.

The telephony device 400 also includes an IP telephony software application 410. The IP telephony software application 410 includes an IP telephony system communication unit 412 which communicates with an IP telephony system 300 as illustrated in FIG. 3. A user interaction unit 414 is configured to interact with the user of the telephony device 400. The user interaction unit 414 can obtain information and instructions from the user, and present information to the user for various purposes.

The IP telephony software application 410 also includes a triggering unit 416 which determines when it is necessary or desirable to cause forwarding instructions to be implemented by a telephony system, such as the native telephony system which provides the telephony device 400 with its native telephony service. The triggering unit 416 may also determine when it is necessary or desirable for previously implemented forwarding instructions to be cancelled. A forwarding instruction unit 418 is responsible for actually causing a telephony system to implement or cancel forwarding instructions.

The IP telephony software application 410 also includes an activity monitoring unit 420 which is responsible for determining when the telephony device is engaged in a function or operation. This could include the user interacting with the telephony device 400 to either accomplish a function or to perform a certain type of activity. As explained above, if the activity monitoring unit 420 determines that the telephony device is already performing a function, and/or that the user is already utilizing the telephony device 400 in some fashion when an incoming telephony communication is received, the user may be given the option to continue the function, rather than immediately accepting the incoming telephony communication.

For purposes of the following explanation, we will assume that the first IP telephony device with cellular capability 109 illustrated in FIG. 1 has the features of the telephony device 400 illustrated in FIG. 4. As a result, the first IP telephony device with cellular capability 109 is capable of accepting an incoming telephony communication from either the IP telephony system 124 or from the mobile telephony service provider A114.

As explained above, the mobile telephony service provider A114 is typically not capable of knowing or determining whether the first IP telephony device with cellular capability 109 is already performing some other function for the user when a new incoming telephony communication directed to the first telephony device 109 is received. As a result, the user of the first IP telephony device 109 may be interrupted by the new incoming telephony communication. To prevent this from occurring, in systems and methods embodying the invention the mobile telephony service provider A114 is instructed to forward all incoming communications directed to the first IP telephony device 109 to the IP telephony system 124. Elements of the IP telephony system 124 and/or elements of the first IP telephony device 109 then determine whether the incoming communication should be received by the IP telephony device, or terminated in some other fashion. This provides the user with much greater control over how incoming telephony communications are handled.

There are many different ways that the mobile telephony service provider A114 could be instructed to forward telephony communications directed to the first IP telephony device 109 to the IP telephony system 124. In some instances, the IP telephony system 124 could directly interact with the mobile telephony service provider A114 in order to instruct mobile telephony service provider A114 to forward such communications. In other instances, the first IP telephony device with cellular capability 109 could send forwarding instructions to the mobile telephony service provider A 114 which instruct that all incoming communications be directed to the IP telephony system 124. In still other instances, a third party forwarding agent 500, as illustrated in FIG. 5, could be utilized to relay forwarding instructions to mobile telephony service provider A114.

Detailed descriptions of various ways in which forwarding instructions can be provided to a first telephony service provider in order to cause the first telephony service provider to forward communications to a second telephony service provider are provided in the following co-pending U.S. applications: application Ser. No. 13/334,849, filed on Dec. 22, 2011; application Ser. No. 13/492,361, filed on Jun. 8, 2012; application Ser. No. 13/562,542, filed on Jul. 31, 2012; application Ser. No. 13/568,461, filed on Aug. 7, 2012; application Ser. No. 13/569,384, filed on Aug. 8, 2012; application Ser. No. 13/597,396, filed on Aug. 29, 2012; application Ser. No. 13/597,916, filed on Aug. 29, 2012; application Ser. No. 13/668,826, filed on Nov. 5, 2012; application Ser. No. 13/671,006, filed on Nov. 7, 2012; application Ser. No. 13/673,043, filed on Nov. 9, 2012; application Ser. No. 13/649,847, filed on Oct. 11, 2012; application Ser. No. 13/671,162, filed on Nov. 7, 2012; application Ser. No. 13/597,485, filed on Aug. 29, 2012; application Ser. No. 13/669,009, filed on Nov. 5, 2012.

The disclosure of all above identified co-pending applications is hereby incorporated by reference.

In many instances, the forwarding instructions which are provided to a separate telephony service provider are provided by either the IP telephony system 124 or by the telephony device itself. However, FIG. 5 shows an alternate situation where a forwarding agent 500, which can be operated by a third party, is responsible for sending forwarding instructions to a mobile telephony service provider A114 or to a mobile telephony service provider B140. In these instances, the IP telephony system 124 could instruct the forwarding agent 500 to send forwarding instructions to either a mobile telephony service provider A114 or a mobile telephony service provider B140. Alternatively, the second IP telephony device 112 with cellular capabilities could instruct a forwarding agent 500 to send forwarding instructions to either the mobile telephony service provider A114 or the mobile telephony service provider B 140. Thus, although the forwarding agent 500 actually relays the forwarding instructions to the mobile telephony service provider, the instructions are caused to be generated and provided by either the IP telephony system 124 or the second IP telephony device with cellular capabilities 112. Cancellation of previously implemented forwarding instructions would be sent in the same fashion.

Once forwarding instructions have been implemented by a native telephony service provider which provides a telephony device with its native telephony service, when a new incoming communication directed to the telephony device is received by the native telephony service provider, the incoming communication is forwarded to a second telephony service provider, such as an IP telephony system. Returning to FIG. 1, assume that the first IP telephony device with cellular capability 109 receives its native telephony service from mobile telephony service provider A114. Assume also that mobile telephony service provider A114 has implemented forwarding instructions such that any incoming telephony communication directed to native identifier of the first IP telephony device with cellular capability 109 is forwarded to the IP telephony system 124. Once the forwarding instructions have been implemented, a method as illustrated in FIG. 6 can be performed in order to control how new incoming telephony communications are terminated to the first IP telephony device with cellular capability 109.

As illustrated in FIG. 6, the method 600 begins and proceeds to step S602 where an IP telephony system 300, such as the one illustrated in FIG. 3, receives a forwarded communication from a telephony service provider. This would be a telephony communication that is directed to the native identifier of a telephony device 400, such as the one illustrated in FIG. 4, and the native telephony service provider for that telephony device 400 will have forwarded the communication to the IP telephony system 300. A forwarded call termination unit 310 of the IP telephony system 300 actually receives the forwarded communication in step S602.

Next, in step S604, the call termination unit 318 of the forwarded call termination unit 310 sends a message to the telephony device 400 regarding the incoming communication. If the call termination unit 318 does not receive any reply to that message, then the forwarded communication is terminated according to predetermined termination instructions. For example, if the call termination unit 318 does not receive any reply to the message sent to the telephony device 400 in step S604, then in step S606 the call termination unit 318 could send the telephony communication to a voice mailbox associated with the telephony device 400. Alternatively, some other pre-determined way of terminating the incoming communication, such as forwarding the communication to an alternate telephone number, could also be accomplished in step S606.

Alternatively, if the call termination unit 318 receives a response back from the telephony device indicating that the user wishes to receive the incoming telephony communication, in step S606 the call termination unit 318 sends the incoming telephony communication to the telephony device 400 in an IP format via a data network. The user of the telephony device 400 could then answer the call.

In yet other embodiments, a response from the telephony device 400 could be received by the call termination unit 318, and the response could indicate how the call is to be terminated. For example, the telephony device 400 could send a response to the message indicating that the user wishes for the communication to be sent to voicemail. In that instance, in step S606 the call termination unit 318 of the IP telephony system 300 sends the communication to an associated voice mailbox.

As it is apparent, the user of the telephony device gains much greater control over how the communication is terminated when a method as illustrated in FIG. 6 is performed.

In some embodiments, the user of the telephony device 400 will establish a set of predetermined call termination instructions which are to be executed by the IP telephony system 300 under certain conditions. For example, the predetermined call termination instructions could indicate that during certain times of the day, any incoming forwarded communications (which were originally directed to the native identifier of the telephony device 400) are to be sent to voicemail. The predetermined termination instructions could also indicate that incoming forwarded communications directed to the native identifier should be terminated in other ways. Further, the predetermined termination instructions could indicate that if the IP telephony system 300 is not in direct contact with the telephony device 400 via a data network, then the IP telephony system 300 should take steps to have the incoming communication terminated to the telephony device 400 via its native telephony service provider. This could involve cancelling previously implemented forwarding instructions, and sending the incoming telephony communication back to the native telephony service provider. Because the forwarding instructions will have been cancelled, the native telephony service provider can terminate the call to the telephony device via normal procedures.

FIG. 7 illustrates steps of a method which is performed by elements of a telephony device 400 in one embodiment of the invention. Before the steps illustrated in FIG. 7 are performed, forwarding instructions will have been implemented by the native telephony service provider for the telephony device 400, and an incoming telephony communication directed to the native identifier of the telephony device 400 will have been forwarded to an IP telephony system 300. The IP telephony system 300 will have received the forwarded communication, and will have sent a message to the telephony device 400 regarding the incoming the telephony communication.

The method illustrated in 700 then begins in step S702, where an IP telephony system communication unit 412 of the telephony device 400 receives the message about the incoming forwarded telephony communication. Next, a user interaction unit 414 of the IP telephony system 400 causes a notification regarding the incoming forwarded communication to be displayed or played to the user. The notification could indicate that an incoming telephony communication is ready to be received. The notification could also include information about that telephony communication, such as caller ID information, or an identity of the calling party which is obtained from a contact list maintained by either the user or on the telephony device 400 using caller ID information.

Next, in step S706, the IP telephony software application 410 causes the incoming telephony communication to be terminated based on either pre-determined termination instructions, or a user's response to the notification. For example, if the user fails to respond to the notification in any fashion, pre-determined termination instructions may indicate that the incoming communication is to be terminated to voicemail. If the user responds to the notification with instructions, the IP telephony software application 410 will handle the incoming communication in accordance with those instructions.

In some instances, the IP telephony software application 410 on the telephony device 400 would handle the ultimate termination of the incoming communication. In alternate embodiments, the IP telephony system communication unit 412 may send a message back to the IP telephone system 300 instructing the IP telephony system 300 as to how the communication is to be terminated. If the user responds to a notification sent from the IP telephony system 300 in some fashion, then the user's response could be used to determine how the incoming communication is to be terminated. Here again, the user's response could be sent back to the IP telephony system by the IP telephony system communication unit 412 of the telephony device 400.

In some embodiments, it may be desirable to have the native telephony system implement forwarding instructions at virtually all times so that any incoming communications directed to the native identifier of a telephony device 400 are automatically forwarded to an IP telephony system 300, which then decides how to terminate the communication, or which then interacts with the telephony device 400 to determine how to terminate the communication. In other embodiments, the forwarding instructions could be implemented and then later cancelled depending upon a status of the telephony device, or on other factors.

For example, a native telephony service provider may be instructed to implement forwarding instructions only when the associated telephony device 400 is already engaged in an IP telephony communication set up by the IP telephony system 300. While the IP telephony communication set up through the IP telephony system 300 is ongoing, any incoming telephony communications directed to the native identifier of the telephony device 400 are forwarded to the IP telephony system 300. The IP telephony system 300 could then handle termination of those communications. This would prevent a telephony communication directed to the native identifier of the telephony device 400 from interrupting the ongoing IP telephony communication being conducted through the IP telephony system 300. Once the IP based telephony communication conducted through the IP telephony system 300 terminates, the forwarding instructions could be cancelled such that any future telephony communications directed to the native identifier of the telephony device 400 are handled by the native telephony service provider in a normal manner.

In another example, if the IP telephony software application 410 on the telephony device knows that the user is conducting some type of activity with the IP telephony device, forwarding instructions could be implemented so that any incoming communications directed to the native identifier of the telephony device 400 are forwarded to the IP telephony system 300, and the communications are then handled as described above. Here again, this would prevent an incoming telephony communication directed to the native identifier of the telephony device from interrupting the ongoing activity being conducted by the user on the telephony device 400.

FIG. 8 illustrates steps of a method 800 which could be performed to selectively implement and then later cancel forwarding instructions, as described above. The method illustrated in FIG. 8 could be performed by the IP telephony system 300, or by elements of an IP telephony device 400, or the method could be performed by the coordinated activities of elements of the IP telephony system 300 and the IP telephony device 400.

The method 800 would begin and proceed to step S802, where a determination is made as to whether a condition of the telephony device 400 is satisfied. The condition could be whether the telephony device 400 is conducting an existing telephony communication through the IP telephony system 300, as described above. Alternatively, the condition could be whether the telephony device 400 is engaged in some other type of activity at the present time. If the determination made is step S802 indicates that the telephony device 400 is not engaged in an existing communication or is not performing some other activity, this would mean that the condition of the telephony device 400 is not satisfied. As a result, the method would proceed to step S804 where a delay period is allowed to expire. The method then returns to step S802, where another determination is made as to whether a condition of the telephony device is satisfied. Steps S802 and S804 would continue to repeat until a condition is determined to have been satisfied in step S802. At that point, the method would proceed to step S808.

In step S808, either the telephony device 400 or the IP telephony system 300 would cause forwarding instructions to be implemented by the native telephony service provider for the telephony device 400. This could involve the forwarding instruction unit 316 of an IP telephony system 300 sending forwarding instructions to the native telephony service provider. Alternatively, a forwarding instruction unit 418 of an IP telephony software application 410 on a telephony device 400 could cause the forwarding instructions to be implemented by the native telephony service provider.

The method then proceeds to step S810, where a determination is made as to whether the condition of the telephony device 400 is still satisfied. For example, if the condition is that the telephony device 400 is conducting a different IP based telephony communication with the IP telephony system 300, the check made is step S810 would determine whether that IP telephony call is still ongoing. If so, the method would proceed to step S812 where a delay period is allowed to expire. The method then returns to step S808 for another determination as to whether the condition of the telephony device 400 is still satisfied. Steps S810 and S812 would continue to be performed in a looping fashion until a determination made in step S810 indicates that the condition of the telephony device 400 is no longer satisfied. When that occurs, the method proceeds to step S816.

In step S816, either the IP telephony system 300 or the telephony device 400 causes the previously implemented forwarding instructions to be cancelled. As a result, when the native telephony system receives an incoming telephony communication directed to the native identifier of the telephony device 400, the communication is sent from the native telephony service provider to the telephony device 400 in a normal fashion. The method returns to step S802, and the method would continue as described above.

The method illustrated in FIG. 8 would continue to be performed so long as the forwarding scheme described above is desired by the user.

The determinations made in steps S802 and S810 could be performed by the triggering unit 314 of the forwarding call termination unit 310 of the IP telephony system 300. Alternatively, the determinations made in steps S802 and S810 could be performed by a triggering unit 416 of IP telephony software application 410 on a telephony device 400. In still other embodiments, the triggering unit 314 of an IP telephony system 300 and the triggering unit 416 on the telephony device 400 could work together to determine whether the condition is satisfied.

In some embodiments of the invention, the user may be able to record a set of preferences or rules that are used to determine how incoming communications are to be handled. The preferences or rules can be based upon activity occurring on the telephony device. Such preferences or rules could be stored on the telephony device itself, or within an IP telephony system which is terminating communications to the user's telephony device. The rules could be applied by the IP telephony system when a forwarded communication is received. Alternatively, the rules could be applied by the user's telephony device when a communication is received at the telephony device from an IP telephony system.

Also, in some of the embodiments described above, the user's telephony device may cause forwarding instructions to be implemented or canceled. The implementation or cancellation of forwarding instructions could be caused by the user's telephony device in response to changes in the activity that is occurring on the user's telephony device. For example, when a certain type of activity begins on the user's telephony device, this may cause the user's telephony device to instruct the native telephony service provider to implement forwarding instructions. Likewise, when the activity ceases, this may cause the user's telephony device to instruct the native telephony service provider to cancel forwarding instructions. Pre-recorded rules about when forwarding instruction are to be implemented and canceled by be stored on the user's telephony device and used to determine when to instruct the native telephony service provider to implement and cancel forwarding instructions.

In many of the examples given above, the methods are used to redirect communications from a mobile telephony device's native telephony service provider to an IP telephony system, and the IP telephony system then terminates the communication to the mobile telephony device via a data network connection. In alternate embodiments, the same procedures can be performed for telephony devices that are not mobile telephony devices. The same basic procedures could be used to redirect communications that were intended for an IP telephone that receives its native service from a different IP telephony system. Likewise, the same basic procedures can also be followed to re-direct communications that are directed to other types of telephony devices by virtually any type of telephony service provider.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of causing the implementation of forwarding instructions that result in the forwarding of telephony communications directed to a native identifier assigned to a telephony device by a first telephony service provider that provides the telephony device with its native telephony service, the method being performed by one or more processors of a second Internet protocol (IP) based telephony service provider, the method comprising:
determining whether at least one condition of the telephony device is satisfied; and
causing forwarding instructions to be implemented by the first telephony service provider if the at least one condition is satisfied, the forwarding instructions causing the first telephony service provider to forward incoming telephony communications that are directed to the native identifier to a forwarding identifier.

2. The method of claim 1, wherein the determining step comprises determining whether the telephony device is presently registered with the second telephony service provider.

3. The method of claim 1, wherein the determining step comprises determining whether the telephony device is presently in communication with the second telephony service provider via a data network.

4. The method of claim 1, wherein after forwarding instructions have been implemented, the method further comprises causing the forwarding instructions to be canceled when the at least one condition is no longer satisfied.

5. The method of claim 1, wherein the determining step comprises determining that the telephony device is presently conducting a telephony communication.

6. The method of claim 5, further comprising:
determining when the telephony device is no longer conducting a telephony communication; and
causing the forwarding instructions to be canceled when it is determined that the telephony device is no longer conducting a telephony communication.

7. The method of claim 1, wherein the determining step comprises determining that the telephony device is presently conducting an operation for the user of the telephony device.

8. The method of claim 1, further comprising:
determining when the telephony device is no longer conducting an operation for the user of the telephony device; and
causing the forwarding instructions to be canceled when it is determined that the telephony device is no longer conducting an operation for the user.

9. A system for causing the implementation of forwarding instructions that result in the forwarding of telephony communications directed to a native identifier assigned to a telephony device by a first telephony service provider that provides the telephony device with its native telephony service, comprising:
means for determining whether at least one condition of the telephony device is satisfied; and
means for causing forwarding instructions to be implemented by the first telephony service provider if the at least one condition is satisfied, the forwarding instructions causing the first telephony service provider to forward incoming telephony communications that are directed to the native identifier to a forwarding identifier.

10. A system for causing the implementation of forwarding instructions that result in the forwarding of telephony communications directed to a native identifier assigned to a telephony device by a first telephony service provider that provides the telephony device with its native telephony service, comprising:
a triggering unit that determines whether at least one condition of the telephony device is satisfied; and
a forwarding instruction unit that causes forwarding instructions to be implemented by the first telephony service provider if the at least one condition is satisfied, the forwarding instructions causing the first telephony service provider to forward incoming telephony communications that are directed to the native identifier to a forwarding identifier.

11. The system of claim 10, wherein the triggering unit determines whether the telephony device is presently registered with the second telephony service provider.

12. The system of claim 10, wherein the triggering unit determines whether the telephony device is presently in communication with the second telephony service provider via a data network.

13. The system of claim 10, wherein after forwarding instructions have been implemented, the forwarding instruction unit causes the forwarding instructions to be canceled when the at least one condition is no longer satisfied.

14. The system of claim 10, wherein after forwarding instructions have been implemented the forwarding instruction unit causes the forwarding instructions to be canceled when the triggering unit determines that the at least one condition is no longer satisfied.

15. The system of claim 10, wherein the triggering unit determines that the at least one condition is satisfied if the telephony device is presently conducting a telephony communication.

16. The system of claim 15, wherein the forwarding instruction unit causes the forwarding instructions to be canceled if the triggering unit determines that the telephony device is no longer conducting a telephony communication.

17. The system of claim 10, wherein the triggering unit determines that the at least one condition is satisfied if the telephony device is presently conducting an operation for the user of the telephony device.

18. The system of claim 17, wherein the forwarding instruction unit causes the forwarding instructions to be canceled if the triggering unit determines that the telephony device is no longer conducting an operation for the user of the telephony device.
